(19) United States
(12) Patent Application Publication
(10) Pub. No.: US 2026/0311699 A1
(43) Pub. Date: Oct. 8, 2026

(54) INFORMATION PROCESSING DEVICE

(71) Applicant: TOYOTA JIDOSHA KABUSHIKI KAISHA, Toyota-shi, (JP)

(72) Inventors: Aya YAMADA KAMISAKA, Tokyo (JP); Takayuki YAMABE, Tokyo (JP); Kota HOSHIBA, Tokyo (JP); Ryota NAKANISHI, Tokyo (JP); Hajime TOJIKI, Tokyo (JP)

(73) Assignee: TOYOTA JIDOSHA KABUSHIKI KAISHA, Toyota-shi (JP)

(21) Appl. No.: 19/535,504

(22) Filed: Feb. 10, 2026

(30) Foreign Application Priority Data
Apr. 2, 2025 (JP) 2025-061165

(51) Int. Cl. G10L 15/22; G06F 16/3329; G06F 16/335

(52) U.S. Cl. CPC G10L 15/22; G06F 16/33295; G06F 16/337; G10L 2015/228

(57) ABSTRACT

An information processing device according to the present disclosure includes a control unit and a storage unit. The storage unit is configured to store behavior history in the past of a user, in association with circumstances at a time of a behavior. The control unit is configured to execute acquiring an utterance from the user, acquiring utterance content by performing speech recognition on the utterance that is acquired, estimating current circumstances of the utterance from the utterance content that is acquired, extracting, from the behavior history stored in the storage unit, behavior history in the past under the same circumstances as current circumstances of the utterance that is estimated, generating a response sentence corresponding to the user, based on the behavior history in the past that is extracted, and outputting the response sentence that is generated to the user.

### CROSS-REFERENCE TO RELATED APPLICATION

This application claims priority to Japanese Patent Application No. 2025-061165 filed on Apr. 2, 2025. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

WO 2020/026799 proposes an information processing device that processes commands to execute functions using demonstrative terms evoked by past memories.

### SUMMARY

One object of the present disclosure is to provide technology that suppresses generation of a response sentence that is contrary to intentions of a user.

An information processing device according to the present disclosure includes a control unit and a storage unit. The storage unit is configured to store behavior history in a past of a user, in association with circumstances at a time of a behavior. The control unit is configured to execute acquiring an utterance from the user, acquiring utterance content by performing speech recognition on the utterance that is acquired, estimating current circumstances of the utterance from the utterance content that is acquired, extracting, from the behavior history stored in the storage unit, behavior history in the past under the same circumstances as current circumstances of the utterance that is estimated, generating a response sentence corresponding to the user, based on the behavior history in the past that is extracted, and outputting the response sentence that is generated to the user.

According to the present disclosure, generation of a response sentence that is contrary to intentions of a user can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates an example of a situation in which the present disclosure is applied;

FIG. 2 schematically illustrates an example of a database of behavior history;

FIG. 3 schematically illustrates an example of a situation in which a response sentence is generated;

FIG. 4 schematically illustrates an example of a hardware configuration of an information processing device according to the present disclosure; and

FIG. 5 is a flowchart showing an example of information processing procedures according to the present disclosure.

### DETAILED DESCRIPTION OF EMBODIMENTS

For example, conventional systems such as WO 2020/026799 and so forth perform processing corresponding to utterances of a user, using correspondence between past dialogue content of the user and operation records. However, the present inventors have found that the conventional system has the following problems. That is to say, conventional systems simply compare utterances of the user with dialogue content in the past, and accordingly there is a possibility that dialogue history in the past that is contrary to the intention of the user making an utterance may be extracted, due to apparent similarity in the dialogue content. For example, when an utterance of the user contains a demonstrative term, the content of the demonstrative term may be erroneously extracted, which may result in the generation of a response sentence that is contrary to the intention of the user.

With respect to this, an information processing device according to the present disclosure includes a control unit and a storage unit. The storage unit is configured to store behavior history in a past of a user, in association with circumstances at a time of a behavior. The control unit is configured to execute acquiring an utterance from the user, acquiring utterance content by performing speech recognition on the utterance that is acquired, estimating current circumstances of the utterance from the utterance content that is acquired, extracting, from the behavior history stored in the storage unit, behavior history in the past under the same circumstances as current circumstances of the utterance that is estimated, generating a response sentence corresponding to the user, based on the behavior history in the past that is extracted, and outputting the response sentence that is generated to the user. According to this configuration, rather than simply comparing the utterance content with past history, the current circumstances estimated from the utterance content are compared with the circumstances of behavior history in the past, and accordingly inferring behavior that the user is most likely to exhibit under the current circumstances can be anticipated. Thus, suppressing the generation of a response sentence that is contrary to the intention of the user can be anticipated.

Note that as other forms of the information processing device according to the above aspect, one aspect of the present disclosure may be an information processing method that realizes all or part of the above components, or may be a program, or may be a storage medium that stores such a program and is readable by a machine such as a computer or the like. The storage medium that can be read by a machine such as a computer or the like is a medium that stores information, such as a program, through electrical, magnetic, optical, mechanical, or chemical action.

### 1. Application Example

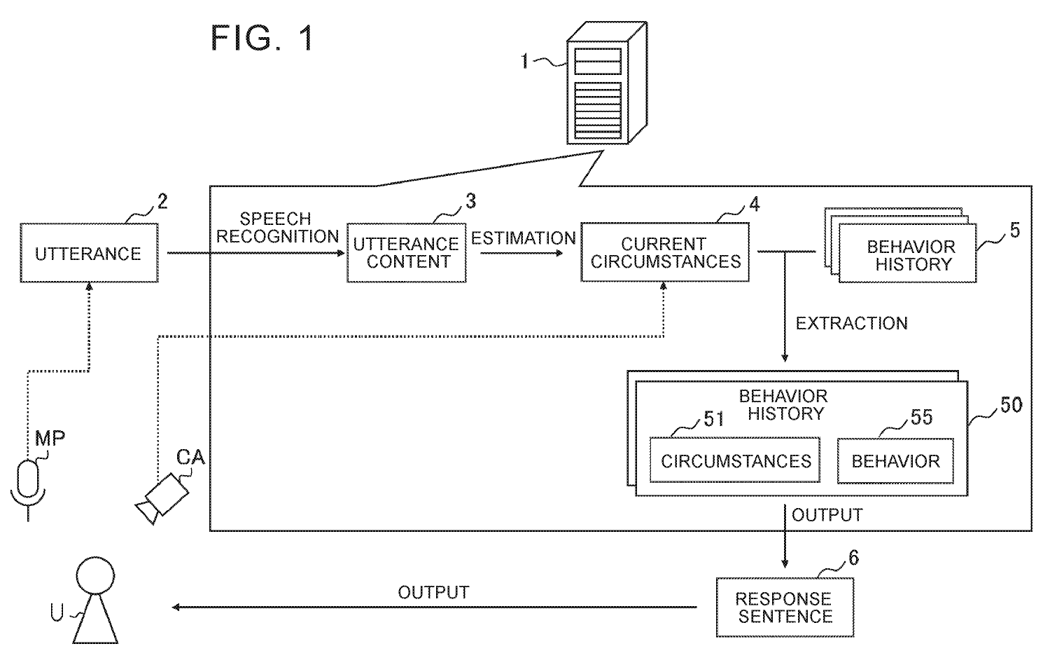

FIG. 1 schematically illustrates an example of a situation in which the present disclosure is applied. An information processing device 1 according to the present disclosure stores behavior history 5 in the past of a user U in association with the circumstances at the time of the behavior. The information processing device 1 acquires an utterance 2 of the user U. The information processing device 1 acquires utterance content 3 by performing speech recognition on the utterance 2 that is acquired. The information processing device 1 estimates current circumstances 4 of the utterance 2 from the utterance content 3 that is acquired. The information processing device 1 extracts, from the behavior history 5 that is stored, behavior history 50 (behavior 55 ) associated with same circumstances 51 in the past as the current circumstances 4 that are estimated. The information processing device 1 generates a response sentence 6 corresponding to the user U based on the behavior history 50 that is extracted. The information processing device 1 then outputs the response sentence 6 that is generated to the user U.

### Utterance

The utterance 2 may include any statement made by the user U. In one example, the utterance 2 may include content requesting the information processing device 1 to perform optional processing. The content of the request does not have to be limited in particular, and may be defined as appropriate, in accordance with the embodiment. For example, the content of the request may be content that indicates a desire of the user U, such as going to a desired eatery, adjusting air conditioning, playing music, and so forth. In this case, the utterance 2 may be a request that includes a demonstrative term, such as "I want to go to that usual eatery".

Also, the utterance 2 may include other statements in addition to the statement requesting the information processing device 1 to perform optional processing. That is to say, the utterance 2 may include any statement that has not been made by the user U to the information processing device 1. For example, the utterance 2 may include a dialogue between the user U and another user.

### Acquiring Utterance Content

Configuration of the utterance content 3 does not have to be limited in particular, as long as the content of the utterance 2 is indicated therein, and may be decided as appropriate in accordance with the embodiment. The information processing device 1 may acquire the utterance content 3 by subjecting the utterance 2 to speech recognition. Speech recognition involves converting audio data of the utterance 2 acquired (by a microphone MP) into digital data, performing analysis thereof, and performing conversion thereof into text data that can be recognized by a computer. A known method may be employed for the method for speech recognition, such as a technique using a hidden Markov model, or the like. In one example of the present embodiment, an utterance 2 (acquired by microphone MP) is acoustically analyzed and converted into digital data, and then phonemes are extracted using an acoustic model. Meaningful words are then constructed from phonemes that are extracted, based on a pronunciation dictionary.

### Estimating Current Circumstances

Methods for estimating the current circumstances 4 of the utterance 2 from the utterance content 3 that is acquired do not have to be limited in particular, and may be defined as appropriate in accordance with the embodiment. In one example, estimating the current circumstances 4 may involve estimating (identifying) the contents of one or more elements (components) that make up the current circumstances 4. The components of the current circumstances 4 do not have to be limited in particular as long as they indicate the circumstances of the user U when the utterance 2 was made, and may be selected as appropriate in accordance with the embodiment.

In one example, the components of the current circumstances 4 may include a theme. The content of the theme does not have to be limited in particular, and may be selected as appropriate in accordance with the embodiment. For example, the theme may be selected from types that are defined in advance. The type may be defined as the kind of a topic, such as dining, news, air temperature, and so forth. Methods for identifying the theme do not have to be limited in particular, and may be defined as appropriate in accordance with the embodiment. In one example, the information processing device 1 may identify a theme using a trained machine learning model (estimation model) that has acquired the ability to identify a theme from the contents of an utterance given as input data. The information processing device 1 may identify the theme by providing the utterance content 3 that is acquired as input data to the machine learning model. A large-scale generative model or the like may be used for the machine learning model. Large-scale generative models may include large-scale language models, large-scale visual language models, large-scale audio models, and so forth.

In one example, the components of current circumstances 4 may include a part of day. The part of day may be a division of a day into certain periods. For example, the part of day may be a day classified into periods such as morning, afternoon, evening, and night, or may be classified into fixed time sections such as "9:00 to 12:00", "12:00 to 15:00", or the like. The fixed time sections may be defined in any way. Method for identifying the part of day do not have to be is not limited in particular, and may be defined as appropriate in accordance with the embodiment. In one example, the information processing device 1 may acquire a clock time at which the utterance 2 was made, determine which classification the clock time belongs to, and thus identify the part of day.

In one example, the components of the current circumstances 4 may include a companion. The companion may be a person who was present with the user U when the utterance 2 was made. The companion may be defined by a name of an individual, or by type. The type may be selected as appropriate in accordance with the embodiment, such as family, friend, colleague, or the like. Note that when there is no companion, the companion content may include a type indicating that the utterance 2 was made by the user U alone, such as "no companion". Methods for identifying the companion do not have to be limited in particular, and may be defined as appropriate in accordance with the embodiment. In one example, the information processing device 1 may identify the "companion” using a captured image captured by a camera CA or the like. A known image recognition technique may be employed as the method to identify the companion in the captured image. In another example, the information processing device 1 may analyze a voiceprint from the utterance 2 that is acquired, to identify the companion. A known method may be employed to analyze the voiceprint.

In one example, the components of the current circumstances 4 may include the surrounding environment. The surrounding environment may be made up of at least one of weather, temperature, and humidity. The weather may include sunny, rainy, cloudy, and so forth. The temperature and humidity may be classified into certain ranges, such as "15 °C to 20 °C" and "30% to 50%", or the like. Classification ranges for the temperature and the humidity may be defined in any way. Methods for identifying the surrounding environment do not have to be limited in particular, and may be defined as appropriate in accordance with the embodiment. When the surrounding environment includes the weather, the information processing device 1 may identify the weather using a captured image captured by the camera CA or the like. A known image recognition technique may be employed as the method to identify the surrounding weather from the captured image. When the surrounding environment includes the temperature or the humidity, the information processing device 1 may identify the temperature or the humidity using a sensor. Note that the information processing device 1 may identify the surrounding environment by acquiring information regarding the weather, the temperature, and the humidity in the vicinity of the location where the utterance 2 was made, from an external computer.

In one example, the components of the current circumstances 4 may include location. The location may be a name of a place or a section defined for each certain range. Methods for identifying the location do not have to be limited in particular, and may be defined as appropriate in accordance with the embodiment. In one example, the information processing device 1 may acquire location information of the location where the utterance 2 was made, and identify the name of the place or the section based on the location information that is acquired.

### Behavior History

The content of the behavior history 5 does not have to be limited in particular, as long as past behavior of the user U is stored in association with the circumstances at the time of that behavior, and may be defined as appropriate in accordance with the embodiment. The components of the circumstances at the time of the behavior may be the same as the components of the current circumstances 4 described above. The behavior may indicate any activity by the user U. The behavior may include, for example, behavior of visiting a shop, searching on a website, playing music, and so forth. Methods for identifying the behavior do not have to be limited in particular, and may be defined as appropriate in accordance with the embodiment. In one example, the behavior may be identified from operation history of equipment. For example, the behavior may be identified as playing music, in accordance with pressing a play button on an audio player. Note that the equipment to be operated may be the same as the information processing device 1, or may be a device that is different from the information processing device 1 (user terminal, in-vehicle equipment, etc.). In another example, the behavior may be identified from the location information of the user U. For example, in accordance with a point indicated by the location information remaining at a particular shop for a certain amount of time or more, the behavior may be determined to be a visit to that shop.

The behavior history 5 may be stored in any memory resource. In one example, the memory resource may be a storage unit 12 which will be described later. In the memory resource, the behavior history 5 may be stored in accordance with any method. In one example, the memory resource may hold a database DB. The behavior history 5 may be stored in the database DB, and thus be stored in the memory resource. The data format of the database DB is not limited in particular, and may be selected as appropriate in accordance with the embodiment. In one example, any format such as a relational database, a blockchain-based database, or the like, may be employed as the data format of the database DB.

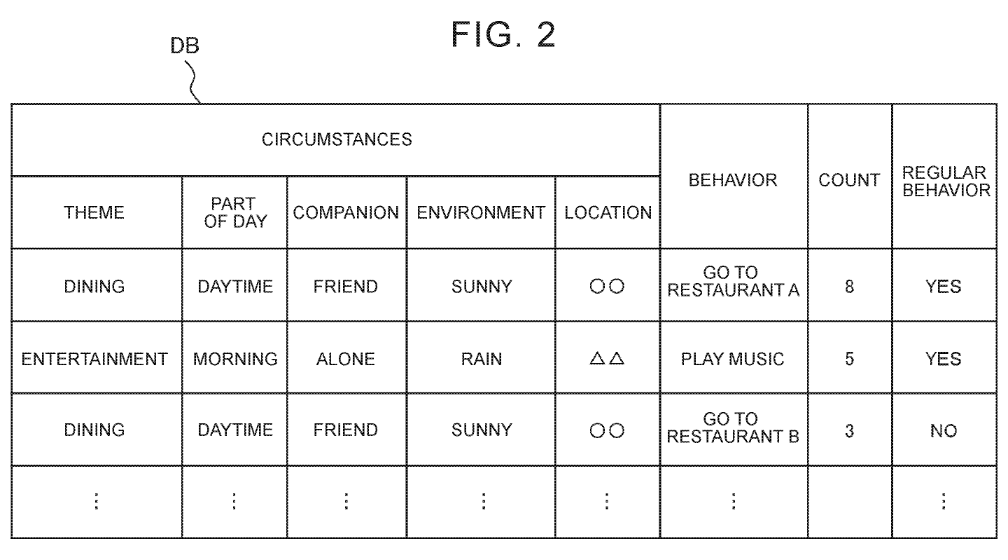

FIG. 2 schematically illustrates one example of the database DB of the behavior history 5. In the example in FIG. 2, the database DB is in the form of a relational database, and includes theme, part of day, companion, surrounding environment, and location, as components of circumstances. Each record corresponds to one behavior history 5. Each record of the past behavior history 5 may record the content of the component, and the behavior carried out in these circumstances. The database DB may also include a field (count field) for storing how many times this behavior has been carried out in those circumstances, and a field for storing whether the behavior is a regular behavior. Methods for determining whether a behavior is a regular behavior do not have to be limited in particular, and may be decided as appropriate in accordance with the embodiment. In one example, whether a behavior is a regular behavior may be decided based on whether the behavior has been carried out the most frequently among behaviors under the same circumstances. For example, a postulation will be made that there is a record in which the content of the behavior carried out in circumstances in which the theme is "dining", the part of day is "daytime", the companion is "friend", the surrounding environment is "sunny", and the location is unspecified, is "go to restaurant A" and "go to restaurant B". In the example of FIG. 2, the number of times of "go to restaurant A" (eight times) among the behavior carried out under these circumstances is greater than the number of times "go to restaurant B" (three times), and accordingly "go to restaurant A" may be recognized as a regular behavior.

Note that the behavior history 5 may be accumulated (added) to the database DB by any method. The behavior history 5 may be added to the database DB at any timing after the user U carries out a behavior. When there is no record existing with the same circumstances and behavior as the circumstances and behavior of the behavior history 5 that is newly added, adding the behavior history 5 to the database DB may be made up of adding a record with the new circumstances and behavior. Also, when there is a record existing with the same circumstances and behavior as the circumstances and the behavior of the behavior history 5 that is newly added, adding the behavior history 5 to the database DB may be made up of incrementing the value of the count field in that record by 1.

### Extraction of Behavior History

Methods for extracting the behavior history 50 in the past in the same circumstances as the current circumstances 4 of the utterance 2 that is estimated do not have to be limited in particular, and may be selected as appropriate in accordance with the embodiment. In a typical example, the method of extracting the behavior history 50 may be a method of extracting by accessing the database DB of the behavior history 5 stored in the memory resource. That is to say, the information processing device 1 may use the current circumstances 4 (contents of components thereof) as a query to extract the behavior history 50 that is the object (records of which the circumstances 51 are the same as the current circumstances 4), from the behavior history 5 in the past.

In one example, the current circumstances 4 of the utterance 2 and the circumstances of the behavior history 5 in the past being the same may be made up of all the components of the current circumstances 4 of the utterance 2 and the components of the circumstances of the behavior history 5 in the past matching. In accordance with this, extracting behavior history 50 in the past for circumstances 51 the same as the current circumstances 4 of the utterance 2 that is estimated may be made up of using the contents of the components of the current circumstances 4 as a query and extracting the behavior history 50 in which the contents of each component all match the contents of the components of the circumstances 51.

In another example, the current circumstances 4 of the utterance 2 and the circumstances of the behavior history 5 in the past being the same may be made up of the components of the current circumstances 4 of the utterance 2 and the components of the circumstances of the behavior history 5 in the past partially matching. In accordance with this, extracting the behavior history 50 in the past for the circumstances 51 the same as the current circumstances 4 of the utterance 2 that is estimated may be made up of using the contents of the components of the current circumstances 4 as a query and extracting the behavior history 50 in which the contents of each component at least partially match the contents of the components of the circumstances 51.

For example, a postulation will be made that when a database DB such as that shown in FIG. 2 is held in a memory resource, the behavior history 50 in the past that is same as the current circumstances 4 (theme is "dining", part of day is "daytime", companion is "friend", surrounding environment is "sunny", and location is unspecified) is extracted. Also, the condition for the circumstances to be the same is that all of the components match. At this time, records with the theme of "dining", the part of day of "daytime", the companion of "friend", the surrounding environment of "sunny", and the location is unspecified, and the records of the behavior field (behavior 55) is "go to restaurant A" and "go to restaurant B", are extracted as the behavior history 50.

### Generating Response Sentence

The information processing device 1 generates a response sentence 6 corresponding to the user U based on the behavior history 50 in the past that is extracted. Methods for generating the response sentence 6 do not have to be limited in particular, and may be defined as appropriate in accordance with the embodiment. The content of the response sentence 6 may be decided as appropriate by the information processing device 1. In one example, the information processing device 1 may generate the response sentence 6 using all of the one or more behavior histories 50 in the past that are extracted. For example, the response sentence 6 may be made up of content, to present information regarding all of the one or more behavior histories 50 in the past that are extracted, and accept a selection from the user U. In another example, the information processing device 1 may generate the response sentence 6 using part of the one or more behavior history 50 in the past that are extracted. The part of the behavior history 50 used in the response sentence 6 may be selected as appropriate. For example, when the database DB of the behavior history 5 includes a field that stores whether each record is a regular behavior, the response sentence 6 may include information regarding the behavior history 50 that was recorded as a regular behavior, from among one or more behavior histories 50 in the past that are extracted.

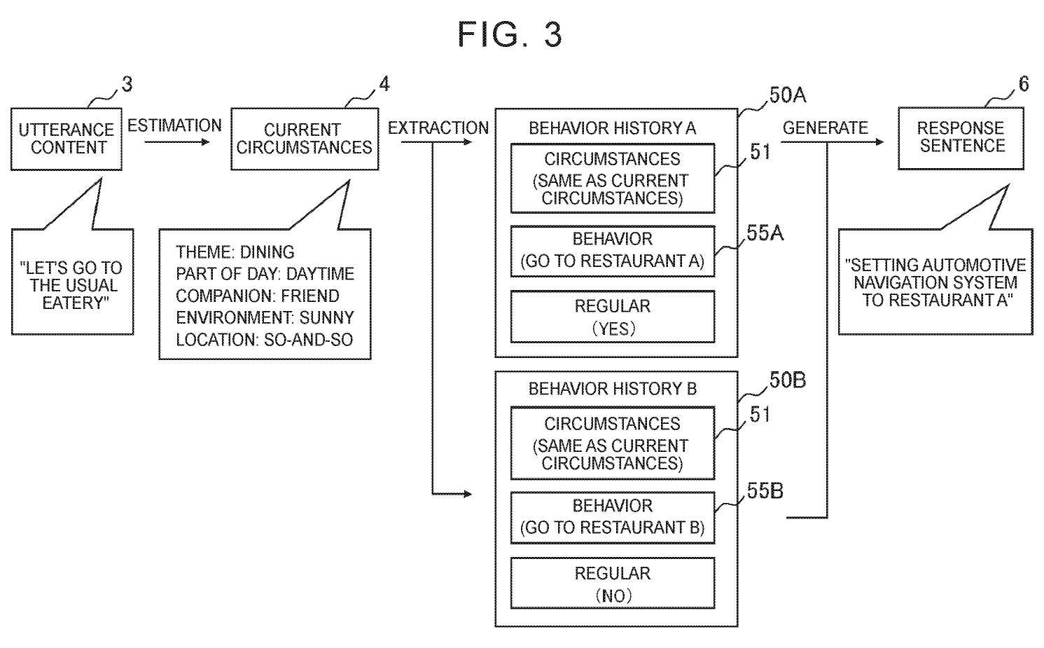

FIG. 3 schematically illustrates one example of a situation in which a response sentence 6 is generated. In the example of FIG. 3, a situation is postulated in which the utterance content 3 in the utterance 2 by the user U is "Let's go to the usual eatery", and in accordance with this, the current circumstances 4 of (theme is "dining", part of day is "daytime", companion is "friend", surrounding environment is "sunny", and location is unspecified) is estimated. In addition, a situation will be postulated in which the database DB holds the records exemplified in FIG. 2, and that the same circumstances are made up of the components of the circumstances at least partially matching. In this case, for the current circumstances 4 that are given, the information processing device 1 extracts records in which the theme is "dining", the part of day is "daytime", the companion is "friend", the surrounding environment is "sunny", and the location is any record, and the behavior field (behavior 55) is "go to restaurant A" and "go to restaurant B," as the behavior history 50 (50A, 50B).

The behavior in the behavior history 50A is "go to restaurant A" (55A), which is recorded as being a regular behavior. The behavior in the behavior history 50B is "go to restaurant B" (55B), which is not recorded as being a regular behavior. The information processing device 1 generates a response sentence 6 including content related to "go to restaurant A" in accordance with "go to restaurant A" being a regular behavior. For example, the content related to "go to restaurant A" may be to set an automotive navigation system to go to restaurant A, and in this case, a response sentence 6 may be generated such as "setting automotive navigation system to restaurant A".

In one example, generating the response sentence 6 may be made up of generating the response sentence 6 using a trained machine learning model (generative model) that has acquired the ability to generate the response sentence 6 from the behavior history 5 in the past of the user U. The configuration of the generative model is not limited in particular, and may be selected as appropriate in accordance with the embodiment. The generative model may be made up of any type of machine learning model. In one example, the generative model may be a large-scale generative model. Large-scale generative models may include large-scale language models, large-scale visual language models, large-scale audio models, and so forth.

When the content indicated by the utterance content 3 is definite, such as "Let's go to restaurant A", and no further information is required to generate the response sentence 6, estimating the current circumstances 4 of the utterance 2, acquiring the behavior history 50 in the past, and generating the response sentence 6 based on the behavior history 50 in the past, may be omitted. On the other hand, when the utterance content 3 includes an uncertain element, such as "Let's go to the usual eatery", the above series of processing may be carried out. Methods for determining whether the content indicated by the utterance content 3 is unclear do not have to be limited in particular, and may be defined as appropriate in accordance with the embodiment. In one example, when the utterance content 3 includes a demonstrative term, determination may be made that the content indicated by the utterance content 3 is unclear. In accordance with this, estimating the current circumstances 4 of the utterance 2, acquiring the behavior history 50 in the past, and generating the response sentence 6 based on the behavior history 50 in the past, may be carried out when the utterance content 3 includes a demonstrative term. The demonstrative term may be of any type, as long as it indicates a specific object, person, location, time, or the like, in the utterance 2, and may be defined as appropriate in accordance with the embodiment. For example, demonstrative terms may include words such as "this", "that", "that over there", "the usual", "he", "she", and so forth.

### Outputting Response Sentence

In a typical example, outputting the response sentence 6 to the user U may be made up of outputting the response sentence 6 as it is. Methods for outputting the response sentence 6 do not have to be limited in particular, and may be selected as appropriate in accordance with the embodiment. For example, the response sentence 6 may be output by an audio output device such as a speaker or the like. The response sentence 6 may also be output by a visual output device such as a display or the like.

In another example, the information processing device 1 may generate the response sentence 6 and also carry out optional information processing. In accordance with this, outputting the response sentence 6 to the user U may be made up of outputting the results of this information processing together with the response sentence 6 or instead of the response sentence 6. The information processing executed together with the response sentence 6 may be selected as appropriate in accordance with the embodiment. In one example, the information processing device 1 may execute processing related to regular behavior (behavior 55) included in the response sentence 6. For example, when the regular behavior is "go to restaurant A" and the response sentence 6 is "setting automotive navigation system to restaurant A", as in the example in FIG. 3, the information processing device 1 may execute actually setting the automotive navigation system to restaurant A.

### Modifying Behavior History

When the behavior history 50 in the past that is extracted does not match the intention of the user U, the content of the response sentence 6 that is output may be inappropriate. Accordingly, after outputting the response sentence 6 to the user U, the information processing device 1 may accept, from the user U, a modification request regarding the extracting of the behavior history 50 in the past. The format for accepting a modification request does not have to be limited in particular, and may be defined as appropriate in accordance with the embodiment. For example, the information processing device 1 may accept speech input for a certain period of time. When the content of the speech input is negative, such as "that's wrong", the information processing device 1 may determine that the extraction of the behavior history 50 in the past was incorrect. The information processing device 1 may modify the behavior history 5 in the past that is stored in the memory resource, in accordance with a modification request accepted from the user U. For example, when the behavior that has been carried out the greatest number of times (number of times carried out) among behaviors under the same circumstances has been recorded as a regular behavior, a behavior different from this behavior may be re-recorded as the regular behavior.

In the example of FIG. 3, a case is postulated in which the utterance content 3 of the user U is "Let's go to the usual eatery," and that the user U intends restaurant B for the "usual restaurant". In this case, a situation will be postulated in which, after the response sentence 6 "setting automotive navigation system to restaurant A" is output, a modification request is accepted, resulting in the user U inputting something like "the usual eatery is not restaurant A". In this case, the information processing device 1 may modify the behavior history 5 (50A, 50B) in the past, stored in the memory resource. For example, the information processing device 1 may modify "go to restaurant A" (55A) as not being regular behavior, and modify "go to restaurant B" (55B) as being regular behavior.

Note that the method for modifying the behavior history 5 is not limited to this example. In one example, when the behavior that has been performed the most frequently has been recorded as a regular behavior, and the user U makes a modification request, the information processing device 1 may modify the behavior history 5 by resetting (setting to 0) the count of the number of times that the behavior has been carried out for all of the behavior histories 50 that are extracted. For example, when the behavior history 5 is stored in the database DB as shown in FIG. 2, the information processing device 1 may modify the behavior history 5 by setting the value of the count field of the record to be modified to 0.

### 2. Configuration Example

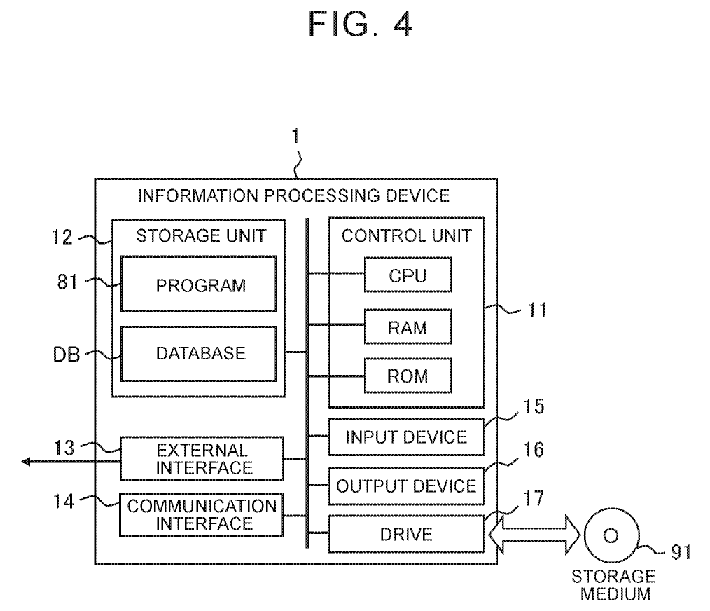

FIG. 4 schematically illustrates an example of a hardware configuration of the information processing device 1. As illustrated in FIG. 4, the information processing device 1 according to the present embodiment is a computer in which a control unit 11, the storage unit 12, an external interface 13, a communication interface 14, an input device 15, an output device 16, and a drive 17, are electrically connected. The control unit 11 includes a central processing unit (CPU), random access memory (RAM), read only memory (ROM), and the like, and is configured to execute any information processing. The storage unit 12 may be made up of a hard disk drive, a solid state drive, or the like, for example. In the present embodiment, the storage unit 12 stores a program 81. The program 81 is a program for causing the information processing device 1 to execute information processing according to the present embodiment. The program 81 includes a series of commands for this information processing.

The external interface 13 may be, for example, a Universal Serial Bus (USB) port, a dedicated port, a wireless communication port, or the like, and is configured to connect to external devices by wire or wirelessly. In the present embodiment, the information processing device 1 may be connected to the microphone MP, the camera CA, and the like, via the external interface 13. The communication interface 14 is configured to perform wired or wireless data communication over a network. The communication interface 14 may be made up of, for example, a wired (LAN) module, a wireless LAN module, or the like. In the present embodiment, the information processing device 1 may use the communication interface 14 to execute data communication with other computers (e.g., external servers, user terminals, etc.) via a network. The input device 15 is a device for performing input, such as for example, a mouse, a keyboard, buttons, a joystick, a manipulator, or the like. The output device 16 is a device for outputting, such as for example, a display, a speaker, or the like. The input device 15 and the output device 16 may be integrally configured with, for example, a touch panel display or the like.

The drive 17 is a device for reading various types of information such as programs and so forth, stored in the storage medium 91. The program 81 may be stored in the storage medium 91 instead of the storage unit 12, or together with the storage unit 12. The storage medium 91 is configured to store various types of information (stored programs and so forth) by electrical, magnetic, optical, mechanical, or chemical action, such that the information can be read by a machine such as a computer or the like. The information processing device 1 may acquire the program 81 from the storage medium 91. Note that the storage medium 91 may be a disc-type storage medium such as a CD, DVD, or the like, or may be a non-disc-type storage medium such as semiconductor memory (e.g., flash memory) or the like. The type of the drive 17 may be selected as appropriate, in accordance with the type of the storage medium 91.

It should be noted that, with regard to the specific hardware configuration of the information processing device 1, components can be omitted, replaced, or added as appropriate, in accordance with the embodiment. For example, the control unit 11 may include a plurality of hardware processors. The hardware processor may be made up of a microprocessor, a field-programmable gate array (FPGA), a digital signal processor (DSP), a graphics processing unit (GPU), an application specific integrated circuit (ASIC), or the like.

### 3. Operation Example

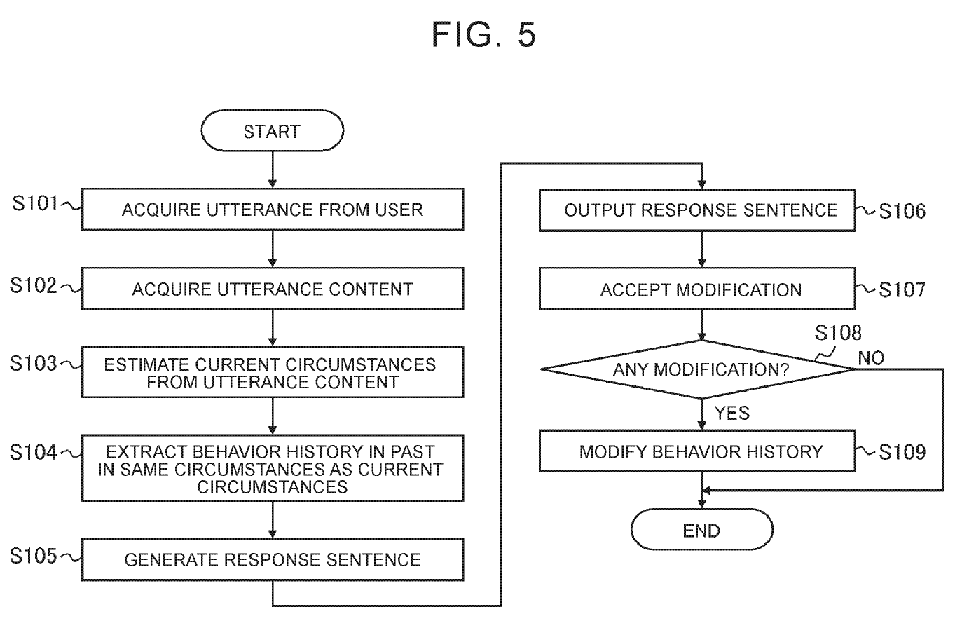

FIG. 5 is a flowchart showing one example of processing procedures of the information processing device 1. The following processing procedures are one example of an information processing method executed by a computer. Note, however, that the following processing procedures are merely one example, and each step may be maximally changed. Also, steps in the following processing procedures can be omitted, substituted, or added as appropriate, in accordance with the embodiment.

### Steps S101 to S102

In step S101, the control unit 11 acquires the utterance 2 of the user U. In one example, the utterance 2 may be acquired by the microphone MP. The utterance 2 may include content in which user U requests the information processing device 1 to perform desired processing. In step S102, the control unit 11 acquires the utterance content 3. In one example, the control unit 11 may acquire the utterance content 3 by performing speech recognition of the utterance 2.

### Steps S103 to S104

In step S103, the control unit 11 estimates the current circumstances 4 of the utterance 2 from the utterance content 3. In one example, estimating the current circumstances 4 may be made up of identifying the content of one or more components that make up the current circumstances 4. For example, the current circumstances 4 may include components related to at least one of a theme, a part of day, a companion, a surrounding environment, and a location. In step S104, the control unit 11 extracts, from the storage unit 12, the behavior history 50 in the past for the circumstances 51 that are the same as the current circumstances 4 of the utterance 2 that is estimated. In one example, the current circumstances 4 of the utterance 2 and the circumstances 51 of the behavior history 50 in the past being the same may be made up of the components of the current circumstances 4 of the utterance 2 and the components of the circumstances 51 of the behavior history 50 in the past fully or partially matching. In accordance with this, extracting the behavior history 50 in the past for the circumstances 51 the same as the current circumstances 4 of the utterance 2 that is estimated may be made up of using the contents of the components of the current circumstances 4 as a query and extracting the behavior history 50 in which the contents of each component fully or partially match the contents of the components of the circumstances 51.

### Steps S105 to S106

In step S105, the control unit 11 generates a response sentence 6 based on the behavior history 50 in the past that is extracted. In one example, the control unit 11 may generate the response sentence 6 using all of the one or more behavior histories 50 in the past that are extracted. In another example, the control unit 11 may generate the response sentence 6 using part of the one or more behavior history 50 in the past that are extracted. For example, when the database DB of the behavior history 5 includes a field that stores whether each record is a regular behavior, the response sentence 6 may include information regarding the behavior history 50 that was recorded as a regular behavior, from among one or more behavior histories 50 in the past that are extracted. In step S106, the control unit 11 outputs the response sentence 6 that is generated to the user U. Outputting the response sentence 6 may be made up of outputting the response sentence 6 as it is, or of outputting results of information processing that was executed in conjunction with the generation of the response sentence 6.

### Steps S107 to S109

In step S107, the control unit 11 accepts a modification request from the user U regarding the extraction of the behavior history 50 in the past. In step S108, the control unit 11 determines whether the user U has made a modification request. Methods of determining whether a modification request has been made does not have to be limited in particular, and may be selected as appropriate in accordance with the embodiment. When there is no modification request, the control unit 11 ends the present processing procedures. When a modification request has been made, the control unit 11 advances the processing to step S109. In step S109, the control unit 11 may modify the behavior history 5 (behavior history 50) in the past which is stored in the storage unit 12, in accordance with the modification request. In one example, when the behavior that has been carried out the most frequently among the one or more behavior histories 50 that are extracted is recorded as a regular behavior, a behavior different from this behavior may be re-recorded as a regular behavior. When this step is completed, the control unit 11 ends the present processing procedures.

### Features

In the present embodiment, in the steps S103 and S104, the control unit 11 estimates the current circumstances 4 of the utterance 2, and extracts the behavior history 50 in the past having the same circumstances 51 as the current circumstances 4. This enables the control unit 11 to obtain behavior data (behavior history 50) that is highly likely to be of content that the user U intends in the current circumstances 4. The response sentence 6 is generated in the step S105 based on this behavior data, and accordingly the control unit 11 can suppress the generation of a response sentence 6 that is contrary to the intention of the user U.

### 4. Modifications

While the embodiment of the present disclosure has been described in detail above, the above description is merely an exemplification of the present disclosure in every respect. It goes without saying that various improvements and modifications can be made without departing from the scope of the present disclosure. The processing and means described in the present disclosure can be freely combined and implemented insofar as no technical contradiction occurs.

For example, between the above steps S102 and S103, the control unit 11 may determine whether the utterance content 3 obtained in step S102 contains an uncertain element (e.g., a demonstrative term such as "the usual"). When the utterance content 3 includes an uncertain element, the control unit 11 may execute the processing of steps S103 to S105. On the other hand, when the utterance content 3 does not include any uncertain elements, the control unit 11 may omit the processing of steps S103 to S105, and generate the response sentence 6 directly from the utterance content 3. When the utterance content 3 includes uncertain elements, the influence of the uncertain elements increases the likelihood that a response sentence that is contrary to the intention of the user (user U) will be generated. In contrast, in the present modification, even when the utterance content 3 contains such uncertain elements, inferring behavior that the user U is most likely to exhibit under the current circumstances 4 can be anticipated, due to comparing the current circumstances 4 estimated from the utterance content 3 with the circumstances in the behavior history 5 (circumstances 51) in the past. Accordingly, the effects of the configuration of the present disclosure in suppressing the generation of a response sentence (response sentence 6) that is contrary to the intention of the user (user U) can be more effectively achieved in situations in which such utterance content 3 contains uncertain elements.

Also, for example, when no modification request regarding the extraction of the behavior history 50 in the past is accepted from the user U, the processing of steps S107 to S109 may be omitted in the above processing procedures.

What is claimed is:

1. An information processing device, comprising: a control unit; and a storage unit, wherein
the storage unit is configured to store behavior history in a past of a user, in association with circumstances at a time of a behavior, and
the control unit is configured to execute
acquiring an utterance from the user,
acquiring utterance content by performing speech recognition on the utterance that is acquired,
estimating current circumstances of the utterance from the utterance content that is acquired,
extracting, from the behavior history stored in the storage unit, behavior history in the past under the same circumstances as current circumstances of the utterance that is estimated,
generating a response sentence corresponding to the user, based on the behavior history in the past that is extracted, and
outputting the response sentence that is generated to the user.

2. The information processing device according to claim 1, wherein estimating the current circumstances of the utterance, acquiring the behavior history in the past, and generating the response sentence based on the behavior history in the past, may be executed when the utterance content includes a demonstrative term.

3. The information processing device according to claim 1, wherein components of the current circumstances of the utterance relate to at least one of theme, part of day, companion, surrounding environment, and location.

4. The information processing device according to claim 1, wherein the current circumstances of the utterance and the circumstances of the behavior history in the past being the same is made up of components of the current circumstances of the utterance and components of the circumstances of the behavior history in the past fully or partially matching.

5. The information processing device according to claim 1, wherein
the control unit is configured to further execute
accepting from the user, following outputting the response sentence to the user, a modification request regarding the extracting of the behavior history in the past, and
modifying the behavior history in the past that is stored in the storage unit in accordance with the modification request accepted from the user.
